(19) United States
(12) Patent Application Publication
(10) Pub. No.: US 2011/0040492 A1
(43) Pub. Date: Feb. 17, 2011

(54) SYSTEM AND METHOD FOR MEASURING PHASE RESPONSE CHARACTERISTIC OF HUMAN-BODY IN HUMAN-BODY COMMUNICATION

(75) Inventors: Jung-Hwan Hwang, Daejon (KR); Sung-Weon Kang, Daejon (KR); Kyung-Soo Kim, Daejeon (KR); Jung-Bum Kim, Daejon (KR); In-Gi Lim, Daejon (KR); Chang-Hee Hyoung, Daejon (KR); Sung-Eun Kim, Seoul (KR); Jin-Kyung Kim, Daejon (KR); Hyung-Il Park, Daejon (KR); Tae-Wook Kang, Daejon (KR); Hey-Jin Myoung, Seoul (KR)

Correspondence Address: Jefferson IP Law, LLP, 1130 Connecticut Ave., NW, Suite 420, Washington, DC, 20036, US

(73) Assignees: SAMSUNG ELECTRONICS CO., LTD., Suwon-city, Gyeonggi-do (KR); Electronics and Telecommunications Research Institute

(21) Appl. No.: 12/988,964

(22) PCT Filed: Oct. 14, 2008
(86) PCT No.: PCT/KR08/06047

§ 371 Date: Oct. 21, 2010

(30) Foreign Application Priority Data
Apr. 28, 2008 (KR) 10-2008-0039283

(51) Int. Cl. G06F 19/00

(52) U.S. Cl. 702/19

(57) ABSTRACT

There is provided a system and a method for measuring phase response characteristic of a human body in human-body communication. The system and method may be useful to measure phase response characteristic of the human body without forming a common ground line between a reference signal transmitter and a reference signal receiver by transmitting a first reference signal through the human body and transmitting a second reference signal through the optical cable.

### TECHNICAL FIELD

The disclosed embodiments relate to a system and method for measuring phase response characteristic of a human body in human-body communication in which data are transmitted/received through the medium of the human body, and more particularly, to a system and method for measuring phase response characteristic of a human body by electromagnetically coupling grounds of a signal transmitter and a signal receiver.

### BACKGROUND ART

In contemporary society, many people are always carrying electronic equipment such as PDAs, mobile phones, medical equipment, etc. Signal transmission systems for transmitting a variety of data between these electronic equipments include a line transmission system using a cable, and a wireless transmission system using radio wave and light, etc.

The line transmission system has an advantage regarding the security of transmitted data and the high data transmission rate, but also has a disadvantage that a user should always carry spare parts such as a cable, etc. Also, the wireless transmission system has an advantage in the ease of data transmission, but also has the problem of requiring additional circuits for wireless transmission, which leads to an increase in manufacturing costs.

In order to solve the above-mentioned problems of the line transmission system and the wireless transmission system, there has been proposed human-body communication using a human body as a transmission medium. That is, human-body communication is realized by applying a signal, which is outputted through a transmitter of a communication apparatus, to a human body through an electrode that is in contact with the human body, transmitting the signal through the medium of the human body and receiving the transmitted signal in a RECEIVER of another communication apparatus that is contact with the human body. Since human-body communication do not require spare parts such as a cable, etc., they have advantages in that they are easily available in various application fields, and the manufacturing cost associated with communication systems is low since the communication systems do not need additional circuits for the wireless transmissions.

In order to construct a communication system for human-body communication, it is necessary to analyze frequency characteristics of a human body as a channel of the communication system, and the phase response characteristic according to the frequencies of the human body is one of the requirements of the frequency characteristics.

Meanwhile, a closed circuit structure should be formed between the signal transmitter and the signal receiver in order to realize the signal transmission.

In general, this is possible by forming a common ground line between grounds of the signal transmitter and the signal receiver.

However, it is impossible to form a common ground line for the purpose of the human-body communication, but a closed circuit structure may be formed between the signal transmitter and the signal receiver by electromagnetically coupling grounds of the signal transmitter and the signal receiver through the air.

That is, in the human-body communication, the closed circuit structure is formed by an equivalent capacitor of an electromagnetically coupled component formed through the air between the signal transmitter and the signal receiver, and a signal is transmitted through the closed circuit structure.

And a phase response characteristic of a conventional communication system channel measures phase response characteristic by comparing a phase of a signal inputted into the conventional communication system channel with a phase of a signal outputted through the conventional communication system channel.

In this case, the phases of the input signal and output signal are measured on a common ground line coupled to internal grounds of a phase measurer.

However, in the case of human-body communication, it is impossible to form a common ground line between the signal transmitter and the signal receiver since the grounds of the signal transmitter and the signal receiver are not directly coupled but electromagnetically coupled through the air.

Therefore, the problem is that it is impossible to measure the phase response characteristic of a human body in the human-body communication by using the conventional method.

### DISCLOSURE OF INVENTION

### Technical Problem

The present invention is designed to solve the problems of the prior art, and therefore it is an object of the present invention to provide a system and method capable of measuring phase response characteristic according to the frequencies of a human body, which is required for the design of a communication system for human-body communication, and more particularly, to provide a system and method capable of measuring phase response characteristic according to the frequencies of a human body in an optical signal transmitting/receiving mode under an electromagnetic coupling condition in the human body to which grounds of a reference signal transmitter and a reference signal receiver are not directly coupled but coupled through the air.

### Technical Solution

According to an aspect of the present invention, there is provided a reference signal transmitter for measuring phase response characteristic of a human body in human-body communication, comprising: a reference signal generator generating a reference signal; a reference signal distributor distributing the reference signal into first and second reference signals; a transmitting electrode making contact with a human body to apply the first reference signal to the human body; and an optical signal transmitter receiving the second reference signal and applying the received second reference signal to an optical cable.

In this case, the optical signal transmitter converts the second reference signal into an optical signal.

According to another aspect of the present invention, there is provided a system for measuring phase response characteristic of a human body in human-body communication, comprising: a reference signal transmitter distributing a reference signal into first and second reference signals to transmit the first reference signal through a human body and transmit the second reference signal through an optical cable; and a phase measurer measuring phases of the first reference signal transmitted through the human body and the second reference signal transmitted through the optical cable and calculating phase response characteristic of the human body by comparing the two measured phases.

In this case, the reference signal transmitter converts the second reference signal into an optical signal and applies the converted optical signal to the optical cable.

Also, the reference signal transmitter comprises: a reference signal generator generating a reference signal; a reference signal distributor distributing the reference signal into first and second reference signals; a transmitting electrode making contact with a human body to apply the first reference signal to the human body; and an optical signal transmitter receiving the second reference signal, converting the received second reference signal into an optical signal, and applying the converted optical signal to an optical cable.

In addition, the phase measurer further comprises: a receiving electrode receiving the first reference signal transmitted through the human body; and a reference signal receiver receiving the second reference signal transmitted through the optical cable.

Additionally, the reference signal receiver comprises an optical signal receiver receiving the second reference signal transmitted through the optical cable and converting the received second reference signal into an electrical signal.

Furthermore, the phase measurer receives both of the first and second reference signals using a common ground line formed between the receiving electrode and the reference signal receiver.

According to still another aspect of the present invention, there is provided a reference signal transmitting method for measuring phase response characteristic of a human body in human-body communication, comprising: generating a reference signal; distributing the generated reference signal into a first reference signal to be transmitted through a human body and a second reference signal to be transmitted through an optical cable; and transmitting the distributed first and second reference signals by applying the first reference signal to the human body and applying the second reference signal to the optical cable.

In this case, the transmitting the distributed first and second reference signals comprising: converting the second reference signal into an optical signal and applying the converted optical signal to the optical cable.

According to yet another aspect of the present invention, there is provided a method for measuring phase response characteristic of a human body in human-body communication, comprising: receiving a first reference signal transmitted through a human body and a second reference signal transmitted through an optical cable; measuring phases of the two received first and second reference signals; and calculating phase response characteristic of the human body by comparing the two measured phases.

In this case, the receiving of the first and second reference signals comprises: converting the second reference signal transmitted through the optical cable into an electrical signal.

Also, the method may further comprises: comprising: distributing a reference signal into the first and second reference signals and transmitting the first and second reference signals by applying the first reference signal to the human body and applying the second reference signal to the optical cable.

Additionally, the method may further comprises: second reference is converted into an optical signal and applying the converted optical signal to the optical cable.

Furthermore, the receiving of the first and second reference signals comprises: receiving both of the first and second reference signals using a common ground line formed between a receiving electrode and a reference signal receiver, the receiving electrode receiving the first reference signal transmitted through the human body, and the reference signal receiver receiving the second reference signal transmitted through the optical cable.

### ADVANTAGEOUS EFFECTS

As described above, the system and method according to one exemplary embodiment of the present invention may be useful to measure phase response characteristic of a human body in human-body communication under an electromagnetic coupling condition which is formed through the air between the signal transmitter and the signal receiver in the human body where a common ground line may not be formed between a signal transmitter and a signal receiver.

### BRIEF DESCRIPTION OF THE DRAWINGS

FIG. 1 is a diagram illustrating a system for measuring phase response characteristic of a human body in a human-body communication according to one exemplary embodiment of the present invention.

FIG. 2 is a diagram illustrating a detailed configuration of a reference signal transmitter as shown in FIG. 1.

FIG. 3 is a diagram illustrating a detailed configuration of a reference signal receiver as shown in FIG. 1.

FIG. 4 is a diagram illustrating a method for measuring phase response characteristic of a human body in a human-body communication according to one exemplary embodiment of the present invention.

### BEST MODE FOR CARRYING OUT THE INVENTION

Hereinafter, exemplary embodiments of the present invention, which may be easily put into practice by those skilled in the art to which the present invention belongs, will be described in detail referring to the accompanying drawings. However, it should be understood that, in the detailed description of an operation principle of the system and method according to exemplary embodiments of the present invention, the descriptions of known parts and their related counterparts are omitted for clarity when they are considered to make the gist of the present invention unnecessarily confusing.

Furthermore, for reference numerals that are marked in the accompanying drawings, parts and their related counterparts that have their similar functions and configurations are represented by the same numbers or their serial numbers.

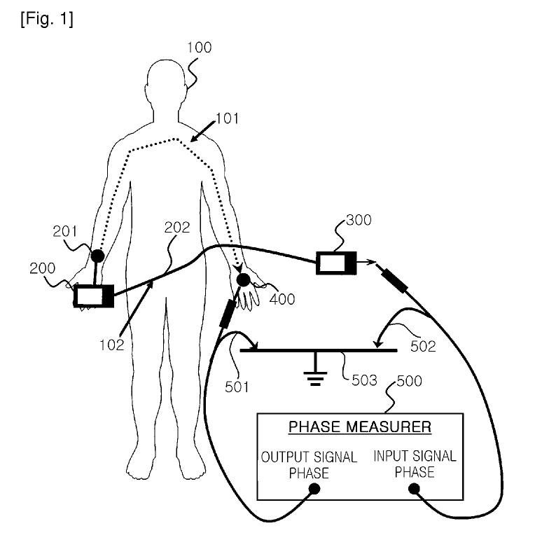

FIG. 1 is a diagram illustrating a system for measuring phase response characteristic of a human body in a human-body communication according to one exemplary embodiment of the present invention. The system according to one exemplary embodiment uses an optical signal transmitting/receiving mode.

Referring to FIG. 1, the system according to the disclosed embodiment includes a reference signal transmitter 200, a reference signal receiver 300 and a phase measurer 500.

First, an operation principle of the system according to the disclosed embodiment will be described in brief.

Here, the reference signal transmitter 200 outputs reference signals into an optical cable 202 and a human body 100, and the reference signal receiver 300 receives the reference signal 102 transmitted through the optical cable 202, and the receiving electrode 400 receives the reference signal 101 transmitted through the human body 100.

And, the phase measurer 500 calculates the difference in phase by comparing a phase of the reference signal received through the optical cable 202 with a phase of the reference signal received through the human body 100.

More particularly, the reference signal transmitter 200 applies the first reference signal 101 to the human body 100 through the transmitting electrode 201 that is in contact with the human body 100. At the same time, the reference signal transmitter 200 applies the second reference signal 102 to the optical cable 202.

The receiving electrode 400 receives the first reference signal 101 that is applied from the reference signal transmitter 200 and transmitted through the human body 100.

The reference signal receiver 300 receives the second reference signal 102 that is applied from the reference signal transmitter 200 and transmitted through the optical cable 202.

The phase measurer 500 measures phases of the first reference signal 101 reached the receiving electrode 400 and the second reference signal 102 received through the reference signal receiver 300, and calculates phase response characteristic of the human body 100 by comparing the two measured phases.

In here, the phase of the first reference signal 101 transmitted through the human body 100 is delayed according to an impedance of the human body 100, but the phase of the second reference signal 102 transmitted through optical cable 202 is not delayed.

Therefore, the phase measurer 500 could obtain phase response characteristic of the human body 100 corresponding to the impedance of the human body 100 by measuring a phase difference between the first reference signal 101 and the second reference signal 102.

In this case, since the two phases of the first and second reference signals may be measured on the common ground line formed between the receiving electrode 400 and the reference signal receiver 300, the phase response characteristic of the human body may be measured using the conventional method for measuring phase response characteristic.

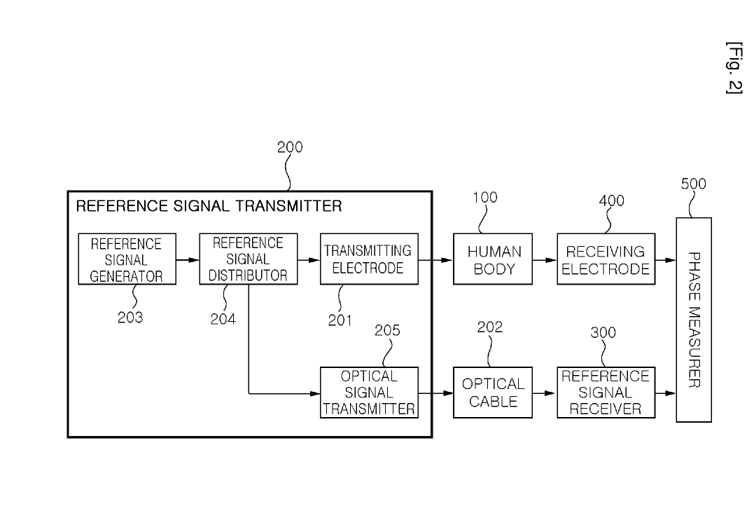

FIG. 2 shows a detailed configuration of a reference signal transmitter 200 as shown in FIG. 1.

Referring to FIG. 2, the reference signal transmitter 200 includes a transmitting electrode 201, a reference signal generator 203, a reference signal distributor 204 and an optical signal transmitter 205.

More particularly, the reference signal generator 203 generates a reference signal, and the reference signal distributor 204 distributes the reference signal into first and second reference signals.

Since the transmitting electrode 201 is in contact with the human body 100, the transmitting electrode 201 applies the first reference signal distributed in the reference signal distributor 204 to the contacted human body 100.

The optical signal transmitter 205 converts the second reference signal distributed in the reference signal distributor 204 into an optical signal, and applies the optical signal to an optical cable 202.

The phase of the first reference signal transmitted through the human body 100 is delayed according to an impedance of human body 100, but the phase of the second reference signal transmitted through the optical cable 202 is not delayed.

In this case, since the phase delay, which is generated when the second reference signal is converted to the electrical signal in optical signal transmitter 205, may be determined by measuring characteristics of the optical signal transmitter 205, the phase delay by the optical signal transmitter 205 may be easily compensated for when calculating the phase response of the human body in human-body communication.

Therefore, in the reference signal transmitter 200 according to one exemplary embodiment, only the first reference signal has a phase delay corresponding to an impedance of human body 100.

As a result, a phase measurer 500 could obtain the phase response characteristic of the human body by measuring phase difference between received reference signals

In addition, the phase measurer 500 receives the first reference signal by using a receiving electrode 400 and receives the second reference signal 102 by using a reference signal receiver 300.

And, the reference signal receiver 300 converts the second reference signal 102 transmitted through the optical cable 202 into an electrical signal and transmits the converted second reference signal to the phase measurer 500 so that the phase measurer 500 could recognize the second reference signal 102.

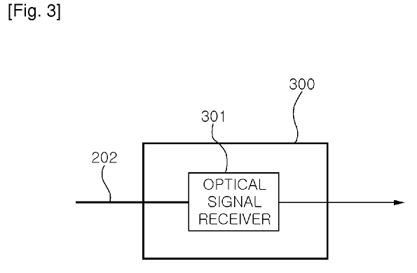

FIG. 3 shows a detailed configuration of a reference signal receiver 300 as shown in FIG. 1. Here, the reference signal receiver 300 includes an optical signal receiver 301.

Referring to FIG. 3, the optical signal receiver 301 receives the optical signal through the optical cable 202, and converts the received optical signal into an electrical signal.

More particularly, the optical signal receiver 301 receives the second reference signal, which has been transmitted from the reference signal receiver 200, through the optical cable 202, and simultaneously converts the received second reference signal into an electrical signal.

In this case, since the phase delay, which is generated when the second reference signal is converted to the electrical signal in the optical signal receiver 301, may be determined by measuring characteristics of the optical signal receiver 301, the phase delay by the optical signal receiver 301 may be easily compensated for when calculating the phase response of the human body in human-body communication.

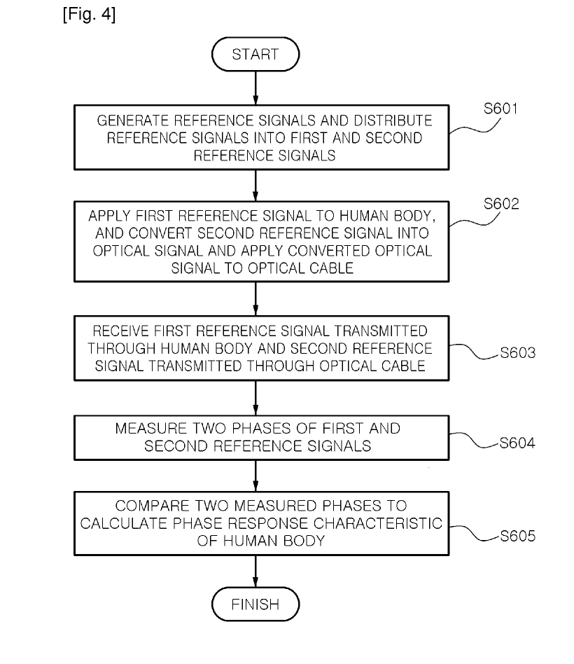

FIG. 4 shows a method for measuring phase response characteristic of a human body in human-body communication according to one exemplary embodiment of the present invention.

Referring to FIG. 4, the reference signal transmitter generates reference signal and distributes the generated reference signal into first and second reference signals (S601), and transmits the first and second reference signals by applying the first and second reference signals through a human body and an optical cable, respectively (S602).

More particularly, the reference signal transmitter generates reference signal and distributes the generated reference signal into the first reference signal to be applied to a human body and the second reference signal to be applied to the optical cable (S601). The distributed first reference signal is transmitted through the human body, and the distributed second reference signal is converted into an optical signal and transmitted through the optical cable (S602).

The first reference signal transmitted through the human body is received through the receiving electrode in the phase measurer, and the second reference signal transmitted through the optical cable is received through the reference signal receiver, converted into an electrical signal, and then received in the phase measurer (S603).

The phase measurer measures two phases of the first and second reference signals received respectively through the receiving electrode and the reference signal receiver (S604), and calculates phase response characteristic of the human body by comparing the two measured phases (S605). Here, the phase measurer receives both of the first and second reference signals using a common ground line formed between the receiving electrode and the reference signal receiver.

The exemplary embodiments of present invention have been described in detail. However, it should be understood that the detailed description and specific examples, while indicating preferred embodiments of the invention, are given by way of illustration only, since various changes and modifications within the scope of the invention will become apparent to those skilled in the art from this detailed description.

1-31. (canceled)

32. A method of sharing information for identifying an authorization key (AK) with a subscriber station in a base station, the method comprising:
sharing a root key with the subscriber station by performing an authentication with the subscriber station;
deriving the AK from the root key; and
sharing an AK sequence number of the AK with the subscriber station,
wherein the AK sequence number is generated by a sequence number of the root key.

33. The method of claim 32, further comprising sharing an AK identifier (AKID) of the AK with the subscriber station,
wherein the AKID is generated by a parameter comprising the AK and the AK sequence number.

34. The method of claim 33, wherein the parameter further comprises a medium access control (MAC) address of the subscriber station and a base station identifier (BSID) of the base station.

35. The method of claim 32, wherein the authentication comprises an extensible authentication protocol (EAP) based authentication, and the root key is a pairwise master key (PMK).

36. The method of claim 35, wherein the AK sequence number is the same as a PMK sequence number of the PMK.

37. The method of claim 36, wherein the PMK sequence number has 4 bits,
wherein 2 bits among the 4 bits are zero bits, and the other 2 bits are effective bits.

38. The method of claim 32, wherein the authentication comprises a Rivest Shamir Adleman (RSA) based authentication, and the root key is a primary authorization key (PAK).

39. The method of claim 38, wherein the AK sequence number is the same as a PAK sequence number of the PAK.

40. The method of claim 39, wherein the PAK sequence number has 4 bits,
wherein 2 bits among the 4 bits are zero bits, and the other 2 bits are effective bits.

41. The method of claim 32, wherein the authentication comprises an EAP based authentication and a RSA based authentication, and the root key comprises a PMK and a PAK.

42. The method of claim 41, wherein the AK sequence number is generated by combining a PMK sequence number of the PMK and a PAK sequence number of the PAK.

43. The method of claim 42, wherein the PMK sequence number has 4 bits, 2 bits among the 4 bits of the PMK sequence number are zero bits, and the other 2 bits are effective bits,
wherein the PAK sequence number has 4 bits, and 2 bits corresponding to the effective bits of the PMK sequence number among the 4 bits of the PAK sequence number are zero bits.

44. The method of claim 42, further comprising:
sharing a new root key with the subscriber station by performing re-authentication with the subscriber station;
deriving a new AK from the new root key; and
sharing an AK sequence number of the new AK with the subscriber station.

45. The method of claim 44, wherein a first sequence number of the new root key and a second sequence number of the root key have 8 bits, respectively,
wherein 4 bits among the 8 bits are zero bits, and the other 4 bits are effective bits, and
wherein the effective bits of the first sequence number are equal to modulo 16 of a value generated by increasing the effective bits of the second sequence number by one.

46. The method of claim 44, wherein a first sequence number of the new root key and a second sequence number of the root key has 4 bits, respectively,
wherein 2 bits among the 4 bits are zero bits, and the other 2 bits are effective bits, and
wherein the effective bits of the first sequence number are equal to modulo 4 of a value by increasing the effective bits of the second sequence number by one.

47. A method of sharing information for identifying an authorization key (AK) with a subscriber station after performing an authentication in a base station, the method comprising:
sharing an AK sequence number of the AK with the subscriber station; and
sharing a PMK sequence number of a pairwise master key (PMK) with the subscriber station,
wherein the AK is derived from the PMK, and
wherein the AK sequence number is generated by the PMK sequence number.

48. The method of claim 47, further comprising sharing an AK identifier (AKID) of the AK with the subscriber station,
wherein the AKID is generated by a parameter comprising the AK, the AK sequence number, a medium access control (MAC) address of the subscriber station, and a base station identifier (BSID) of the base station.

49. A method of sharing authentication information with a subscriber station after performing an extensible authentication protocol (EAP) based authentication in a base station, the method comprising:
sharing a pairwise master key (PMK) derived by the EAP based authentication with the subscriber station; and
sharing a PMK sequence number of the PMK with the subscriber station.

50. The method of claim 49, wherein the PMK sequence number has 4 bits,
wherein 2 bits among the 4 bits are effective bits, and the other 2 bits are zero bits.

51. The method of claim 49, further comprising:
deriving an authorization key (AK) from the PMK; and
sharing an AK sequence number of the AK with the subscriber station,
wherein the AK sequence number is the same as the PMK sequence number.

52. A method of sharing authentication information with a subscriber station after performing a Rivest Shamir Adleman (RSA) based authentication in a base station, the method comprising:
sharing a primary authorization key (PAK) derived by the RSA based authentication with the subscriber station;
sharing a lifetime of the PAK with the subscriber station; and
sharing a PAK sequence number of the PAK with the subscriber station.

53. The method of claim 52, wherein the PAK sequence number has 4 bits,
wherein 2 bits among the 4 bits are effective bits, and the other 2 bits are zero bits.

54. The method of claim 52, further comprising:
deriving an authorization key (AK) from the PAK; and
sharing an AK sequence number of the AK with the subscriber station,
wherein the AK sequence number is the same as the PAK sequence number.

55. A method of sharing information for identifying an authorization key (AK) with a subscriber station after performing an authentication in a base station, the method comprising:
sharing an AK sequence number of the AK with the subscriber station; and
sharing a primary authorization key (PAK) sequence number of a PAK with the subscriber station,
wherein the AK is derived from the PAK, and
wherein the AK sequence number is generated by the PAK sequence number.

56. The method of claim 55, further comprising sharing an AK identifier (AKID) of the AK with the subscriber station,
wherein the AKID is generated by a parameter comprising the AK, the AK sequence number, a medium access control (MAC) address of the subscriber station, and a base station identifier (BSID) of the base station.
